(19) United States
(12) Patent Application Publication
(10) Pub. No.: US 2026/0064980 A1
(43) Pub. Date: Mar. 5, 2026

(54) ALIGNING LARGE LANGUAGE MODELS WITH IN-SITU USER INTERACTIONS AND FEEDBACK

(71) Applicant: Microsoft Technology Licensing, LLC, Redmond, WA (US)

(72) Inventors: Taiwei SHI, Los Angeles, CA (US); Jennifer Lynay NEVILLE, West Lafayette, IN (US); Sujay Kumar JAUHAR, Kirkland, WA (US); Mengting WAN, Kirkland, WA (US); Longqi YANG, Issaquah, WA (US); Zhuoer WANG, Seattle, WA (US); Pei ZHOU, Bellevue, WA (US)

(73) Assignee: Microsoft Technology Licensing, LLC, Redmond, WA (US)

(21) Appl. No.: 19/000,258

(22) Filed: Dec. 23, 2024

Related U.S. Application Data
(60) Provisional application No. 63/687,721, filed on Aug. 27, 2024.

(51) Int. Cl. G06F 40/40; G06N 3/0475

(52) U.S. Cl. CPC G06F 40/40; G06N 3/0475

(57) ABSTRACT

A data processing system implements a framework that utilizes in-situ user interactions as a source of feedback for improving the training of LLMs to generate outputs that align with user preferences. The framework includes a user preference evaluation pipeline analyzes in-situ user interactions with the LLMs and generates preference information that can be used to improve the training of the LLM to improve the alignment of the LLM with user preferences. The user preference evaluation pipeline includes a feedback signal identification unit that identifies explicit and/or implicit feedback provided by the users in response to content output by the LLM in response to a user prompt. The feedback signal identification unit estimates user satisfaction with a set of satisfaction rubrics and user dissatisfaction with a set of user dissatisfaction rubrics to generate user preference data that can be used to align an LLM with these user preferences.

### BACKGROUND

Large language models (LLMs) have become a foundational element of modern natural language processing (NLP) applications. Despite the impressive capabilities of LLMs, a significant technical problem remains in aligning these models with human preferences to ensure that the output of the models is not only accurate but also aligned with user expectations and values. Hence, there is a need for improved systems and methods that provide a technical solution for aligning LLMs and/or other artificial intelligence (AI) models with user preferences.

### SUMMARY

An example data processing system according to the disclosure includes a processor and a memory storing executable instructions. The instructions when executed cause the processor alone or in combination with other processors to perform operations including obtaining example data from an example user interaction dataset that includes user interactions between human users and a first large language model, wherein a user interaction includes a user prompt, one or more responses from the first large language model to the user prompt, and one or more user reactions to the one or more responses from the first large language model; constructing, using a feedback signal identification unit, a first prompt to a second large language model instructing the second large language model to analyze the user interactions between the human users and the first large language model in the example data and to classify the user interactions according to a set of satisfaction rubrics and a set of dissatisfaction rubrics, the set of satisfaction rubrics being indicative of user satisfaction with a response from the first large language model in response to a prompt from a first user, the set of dissatisfaction rubrics being indicative of user dissatisfaction with the response from the first large language model in response to the prompt from the first user; providing, using the feedback signal identification unit, the first prompt and the example data as an input to the second large language model to cause the second large language model to classify the user interactions between the human users and the first large language model according to the set of satisfaction rubrics and the set of dissatisfaction rubrics and to output feedback signal information; generating, using a preference data construction unit, preference training data for aligning the first large language model with user preferences expressed in the user interactions with the first large language model; and performing fine-tuning training of the first large language model using the preference training data to improve alignment of the first large language model with the user preferences.

An example method implemented in a data processing system includes obtaining example data from an example user interaction dataset that includes user interactions between human users and a first large language model, wherein a user interaction includes a user prompt, one or more responses from the first large language model to the user prompt, and one or more user reactions to the one or more responses from the first large language model; constructing, using a feedback signal identification unit, a first prompt to a second large language model instructing the second large language model to analyze the user interactions between the human users and the first large language model in the example data and to classify the user interactions according to a set of satisfaction rubrics and a set of dissatisfaction rubrics, the set of satisfaction rubrics being indicative of user satisfaction with a response from the first large language model in response to a prompt from a first user, the set of dissatisfaction rubrics being indicative of user dissatisfaction with the response from the first large language model in response to the prompt from the first user; providing, using the feedback signal identification unit, the first prompt and the example data as an input to the second large language model to cause the second large language model to classify the user interactions between the human users and the first large language model according to the set of satisfaction rubrics and the set of dissatisfaction rubrics and to output feedback signal information; generating, using a preference data construction unit, preference training data for aligning the first large language model with user preferences expressed in the user interactions with the first large language model; and performing fine-tuning training of the first large language model using the preference training data to improve alignment of the first large language model with the user preferences.

An example data processing system according to the disclosure includes a processor and a memory storing executable instructions. The instructions when executed cause the processor alone or in combination with other processors to perform operations including obtaining example data from an example user interaction dataset that includes user interactions between human users and a policy large language model, wherein a user interaction includes a user prompt, one or more responses from the policy large language model to the user prompt, and one or more user reactions to the one or more responses from the policy large language model; constructing, using a feedback signal identification unit, a first prompt to an expert large language model instructing the expert large language model to analyze the user interactions between the human users and the policy large language model in the example data and to classify the user interactions according to a set of satisfaction rubrics and a set of dissatisfaction rubrics, the set of satisfaction rubrics being indicative of user satisfaction with a response from the policy large language model in response to a prompt from a first user, the set of dissatisfaction rubrics being indicative of user dissatisfaction with the response from the policy large language model in response to the prompt from the first user; providing, using the feedback signal identification unit, the first prompt and the example data as an input to the expert large language model to cause the expert large language model to classify the user interactions between the human users and the policy large language model according to the set of satisfaction rubrics and the set of dissatisfaction rubrics and to output feedback signal information; generating, using a preference data construction unit, preference training data for aligning the policy large language model with user preferences expressed in the user interactions with the policy large language model; and performing fine-tuning training of the policy large language model using the preference training data to improve alignment of the policy large language model with the user preferences.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram of an example computing environment in which the techniques for aligning described herein are implemented.

FIG. 2 is a diagram showing an example implementation of the user preference evaluation pipeline shown in FIG. 1.

FIG. 3 is a diagram showing an example implementation of the model fine tuning pipeline shown in FIG. 1.

FIG. 4 is a diagram showing an example implementation of the model performance evaluation pipeline shown in FIG. 1.

FIG. 5 is a diagram showing an example of the format of the preference data used in preference training.

FIG. 6A is an example of satisfaction rubrics that are used to determine user preferences according to the techniques disclosed herein.

FIG. 6B is an example of dissatisfaction rubrics that are used to determine user preferences according to the techniques disclosed herein.

FIG. 6C is an example of the satisfaction and dissatisfaction rubrics shown in FIGS. 6A and 6B being applied to an example user interaction with a language model according to the techniques disclosed herein.

FIG. 7A is a flow chart of an example process for aligning large language models with user preferences according to the techniques disclosed herein.

FIG. 7B is a flow chart of an example process for aligning large language models with user preferences according to the techniques disclosed herein.

FIG. 8 is a block diagram showing an example software architecture, various portions of which may be used in conjunction with various hardware architectures herein described, which may implement any of the described features.

FIG. 9 is a block diagram showing components of an example machine configured to read instructions from a machine-readable medium and perform any of the features described herein.

FIGS. 10A-10G include an example prompt that causes a language model to perform classification of user satisfaction at the utterance level based on the satisfaction and dissatisfaction rubrics.

FIG. 11 is an example prompt for constructing user preference data.

FIG. 12 is an example prompt for user-guided evaluation.

### DETAILED DESCRIPTION

Systems and methods for aligning LLMs with user preferences are provided. These techniques provide a technical solution to the technical problem of aligning LLMs so that the models produce outputs that are not only accurate but are also aligned with user expectations and values. Current approaches to aligning the LLMs face significant technical limitations that render these approaches unsuitable. Human annotation of training data to fine tune the behavior of an LLM is a resource-intensive and expensive process, and the training data often has a subject bias of the human annotators tasked with labeling the training data. Training data can also be generated by an LLM, but this approach can create a feedback loop that reinforces existing biases of the model rather than capturing the true diversity of human preferences. The systems and methods provided herein for aligning LLMs with user preferences provide a technical solution to these and other problems associated with aligning LLMs with user preferences.

The systems and methods herein provide a novel framework that utilizes in-situ user interactions as a source of feedback for improving the training of LLMs to generate outputs that align with user preferences. The framework includes a user preference evaluation pipeline analyzes in-situ user interactions with the LLMs and generates preference information that can be used to improve the training of the LLM to improve the alignment of the LLM with user preferences. The user preference evaluation pipeline includes a feedback signal identification unit that identifies explicit and/or implicit feedback provided by the users in response to content output by the LLM in response to a user prompt. The explicit and/or implicit feedback can include textual feedback and/or click feedback that is indicative of user satisfaction and/or dissatisfaction with the LLM responses to the user prompts. The feedback signal identification unit estimates user satisfaction with a set of satisfaction rubrics and user dissatisfaction with a set of user dissatisfaction rubrics to generate user preference data that can be used to align an LLM with these user preferences. A technical benefit of these techniques is that these techniques can reduce the significant computing and energy resources required to operate the LLM by significantly improving the output of the model. Aligning the model with user preferences is that the model is more likely to generate content that is more likely to meet user expectations thereby reducing the likelihood that the user will submit multiple prompts to the model requesting that the model revise or recreate the content until the user is satisfied with the output of the model. These and other technical benefits of the techniques disclosed herein will be evident from the discussion of the example implementations that follow.

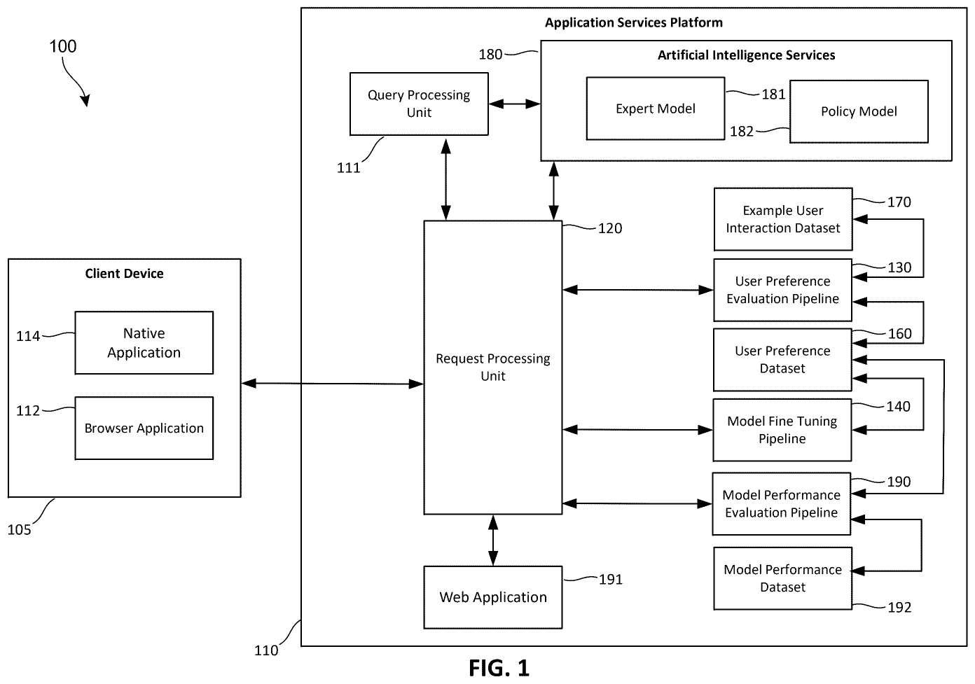

FIG. 1 is a diagram of an example computing environment 100 in which the techniques described herein are implemented. The example computing environment 100 includes a client device 105 and an application services platform 110. The application services platform 110 provides one or more cloud-based applications and/or provides services to support one or more web-enabled native applications on the client device 105. These applications may include but are not limited to design applications, communications platforms, visualization tools, and collaboration tools for collaboratively creating visual representations of information, and other applications for consuming and/or creating electronic content. These applications can utilize one or more LLMs and/or other artificial intelligence models that are capable of generating and/or modifying various types of content in response to a user prompt. The client device 105 and the application services platform 110 communicate with each other over a network (not shown). The network may be a combination of one or more public and/or private networks and may be implemented at least in part by the Internet.

The application services platform 110 implements the framework for aligning LLMs with user preferences. This framework includes a user preference evaluation pipeline 130, a model fine tuning pipeline 140, and a model performance evaluation pipeline 190. The user preference evaluation pipeline 130 analyzes in-situ user interactions with an LLM and generates preference information that can be used to improve the training of the LLM to improve the alignment of the LLM and/or other LLMs with user preferences. The user preference evaluation pipeline 130 generates a user preference dataset 160 that reflects the user preferences identified by the user preference evaluation pipeline 130. The user preference dataset 160 includes instance-level preferences that are associated with specific prompts that were submitted to the LLM and provides guidance on specific examples of favorable and disfavored responses to each prompt. A technical benefit of this approach is that the user preference dataset 160 provides a high level of granularity in the user preference information that can be used to more accurately align the model with these user preferences.

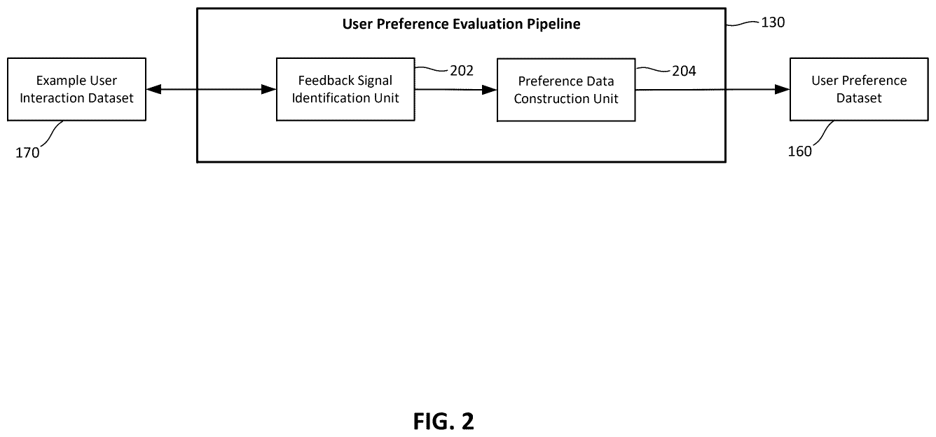

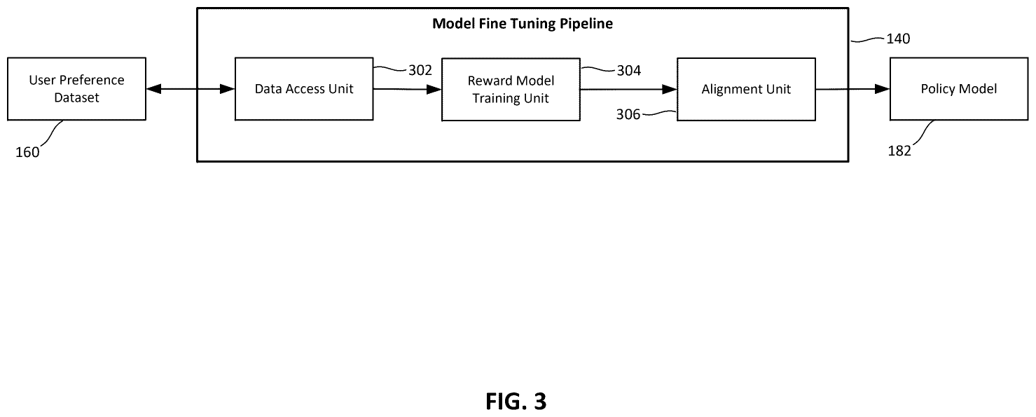

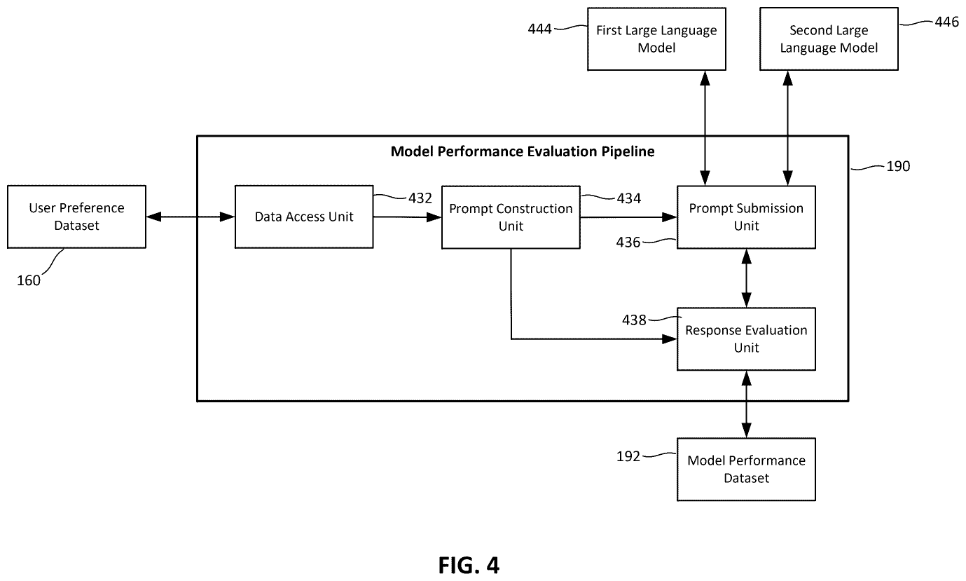

The model fine tuning pipeline 140 utilizes the user preference dataset 160 to fine-tune the training of an LLM to better align with user preferences identified in the in-situ user interactions with the same LLM or another LLM. The model fine tuning pipeline 140 aligns the LLM performance with real user preferences included in the user preference dataset 160. The model performance evaluation pipeline 190 can be used to compare the performance of various models on a dataset selected for evaluating model performance. The model performance evaluation pipeline 190 provides feedback on which models are most aligned with the user preferences based on the real user preference information. An example implementation of the user preference evaluation pipeline 130 is provided in FIG. 2. An example implementation of the model fine tuning pipeline 140 is provided in FIG. 3, and an example implementation of the model performance evaluation pipeline 190 is shown in FIG. 4.

The request processing unit 120 receives requests from an application implemented by the native application 114 of the client device 105 and/or the web application 191 of the application services platform 110. The native application 114 and/or the web application 191 provide a user interface that enables users to input natural language prompts requesting content be generated by the application services platform 110. The content can comprise textual content, documents, program code, structured data, files, and/or other types of content. The textual content can include stories, summaries, articles, translations, and/or other types of textual content. The documents can include documents of various formats that may be viewed and/or modified using the native application 114 and/or the web application 191. The program code can include various types of program code that may be interpreted and/or compiled to create programs that may be executable by the application services platform 110, the client device 105, and/or other computing platforms. The structured data may include JavaScript Object Notation (JSON), Comma Separated Values (CSV), and/or other types of structured data content. The content can also include various types of non-textual content, including but not limited images, videos, audio content, and/or other types of content.

The user can input, in a user interface of the native application 114 of the client device 105 or a user interface of the web application 191 being accessed via the browser application 112 of the client device, a textual prompt requesting that the application services platform 110 generate requested content. The textual prompt can be a natural language prompt that describes what the user would like the model to generate. The prompt is received by the request processing unit 120, and the request processing unit 120 provides the prompt to the query processing unit 111 for processing. The request processing unit 120 also coordinates communication and exchange of data among components of the application services platform 110 as discussed in the examples which follow.

The query processing unit 111 receives a prompt that was input via a user interface of the native application 114 and/or via the web application 191 and provides the prompt as an input to the appropriate model of the AI services 180 and obtains the output from the model. The query processing unit 111 can construct a prompt of the appropriate format for the model based on the query. In some implementations, the query processing unit 111 utilizes a prompt template to construct the prompt that includes pre-engineered prompt language that has been optimized for the particular model for the user query is to be submitted. The prompt template can also include language that instructs the model to apply certain safeguard when executing the model to reduce the likelihood that a malicious prompt could cause the model to perform undesirable actions or produce undesirable outcomes. The query processing unit 111 can also analyze the query to ensure that the query does not include any potentially offensive or obscene materials and/or is not requesting that the model generate such potentially offensive or obscene materials. The query processing unit 111 can rely on a moderation service (not shown) that can analyze the queries and/or the output from the model in response to a query to ensure that no potentially offensive or obscene materials are included. The query processing unit 111 provides the results of the query to the request processing unit 120, and the request processing unit 120 provides the result of the query to the sources of the query, such as the native application 114 or the web application 191.

The AI services 180 provide various machine learning models that analyze and/or generate content. The AI services 180 allocates computing and memory resources on various nodes of the cloud based computing environment to the various AI models managed by the AI services 180. The AI services 180 can allocate resources to the models that are in production and being utilized to process prompts from users, such as the policy model 182, as well as resources to models that are under development. While there are just two models shown in the example implementation of FIG. 1, the AI services can manage multiple models in production and/or models under development. Furthermore, while the models shown in this example are implemented on the cloud-based computing environment of the application services platform 110, the application services platform 110 can also utilize models which are implemented by a third party on a remote cloud-based computing environment and are accessed via a network connection from the application services platform 110.

The AI services 180 can implement various types of models, which may include but are not limited to models configured to generate textual content, image content, video content, and/or other types of content in response to a prompt. The AI models can be implemented using a Large Language Model (LLM) in some implementations. LLMs are artificial neural networks that are characterized by the size of the model. For instance, an LLM may include tens or hundreds of billions or even a trillion weights. Training and executing such models requires significant computing resources and can consume significant amounts of energy. A technical benefit of the techniques for aligning the LLM to user preferences provided in the present application is that the model is likely to reduce the likelihood that the model will need to revise the output of the generate by the model in response to a user prompt, thereby decreasing the consumption of computing resources and energy required to operate the model. The AI services 180 may also implement various Small Language Models (SLMs), which are artificial intelligence networks having a size of a few million to a few billion weights. Thus, SLMs are more efficient and less computationally intensive but may perform with less accuracy than the LLMs.

The models managed by the AI services 180 can implement various model architectures. For the purposes of the techniques provided herein, the models are divided into two logical groupings of models: expert models and policy models. The example implementation shown in FIG. 1 includes expert model 181 and policy model 182. Other implementations may include more than one expert model and/or more than one policy model.

The expert models are used to analyze in-situ user interactions with a policy model, to apply satisfaction and dissatisfaction rubrics identify user satisfaction with responses provided by the LLM, and to summarize these interactions into user preferences and/or to generate examples of favored and/or disfavored responses. In some implementations, the expert model 181 in the present application is implemented by a Generative Pre-Trained Transformer (GPT) language model, such as but not limited to GPT-4, GPT-40, or GPT-4v. The expert model can be implemented using other model architectures in other implementations. The policy model 182 is an LLM for which the alignment of the LLM is evaluated according to the techniques provided herein and for which a user preference dataset 160 is determined that can be used to fine-tune the policy of the model to better align with user preferences. The policy model 182 can be implemented by various types of LLM, such as but not limited to Phi 3, Mistral, or LLAMA 3 models.

The client device 105 is a computing device that may be implemented as a portable electronic device, such as a mobile phone, a tablet computer, a laptop computer, a portable digital assistant device, a portable game console, and/or other such devices. The client device 105 can also be implemented in computing devices having other form factors, such as a desktop computer, vehicle onboard computing system, a kiosk, a point-of-sale system, a video game console, and/or other types of computing devices in other implementations. While the example implementation illustrated in FIG. 1 includes a single client device, other implementations may include a different number of client devices that utilize service provided by the application services platform 110.

The client device 105 includes a native application 114 and a browser application 112. The native application 114 is a web-enabled native application, in some implementations, that enables users to view, create, and/or modify electronic content. The web-enabled native application utilizes services provided by the application services platform 110 including but not limited to creating, viewing, and/or modifying various types of electronic content. The native application 114 can utilize the application services platform 110 to generate various types of content in response to user prompts. In other implementations, the browser application 112 is used for accessing and viewing web-based content provided by the application services platform 110. In such implementations, the application services platform 110 implements one or more web applications, such as the web application 191, that enables users to view, create, and/or modify electronic content. The web application 191 can also utilize the application services platform 110 to generate various types of content in response to user prompts. The application services platform 110 supports both web-enabled native applications and a web application in some implementations, and the users may choose which approach best suits their needs.

FIG. 2 is a diagram showing an example implementation of the user preference evaluation pipeline 130 shown in FIG. 1. The user preference evaluation pipeline 130 analyzes in-situ user interactions with an LLM, such as the policy model 182, from the example user interaction dataset 170 and generates a user preference dataset 160. The user preference dataset 160 includes user preference information that can be used to improve the training of the LLM to improve the alignment of the LLM with user preferences. The user interaction dataset 170 can be generated based on user interactions with a different LLM than the policy model 182. The user interaction dataset 170 can be model agnostic and is relied upon to provide examples of user interactions with an LLM that provide demonstrate user preferences that can be applied to fine-tune the training of an LLM, regardless of whether the LLM is the same model that the user was interacting with in the sample data.

The feedback signal identification unit 202 identifies explicit and/or implicit feedback provided by the users in response to content output by the LLM in response to a user prompt. The explicit and/or implicit feedback can include textual feedback and/or click feedback that is indicative of user satisfaction and/or dissatisfaction with the LLM responses to the user prompts. In a multi-turn conversational session with an LLM, such as policy model 182, the user may explicitly express their satisfaction. For instance, the user may input “thank you” or other such utterances in response to the output by the LLM to express their satisfaction with the output. Similarly, the user may input “revise it” or other such utterances in response to the output by the LLM to express their dissatisfaction with the output.

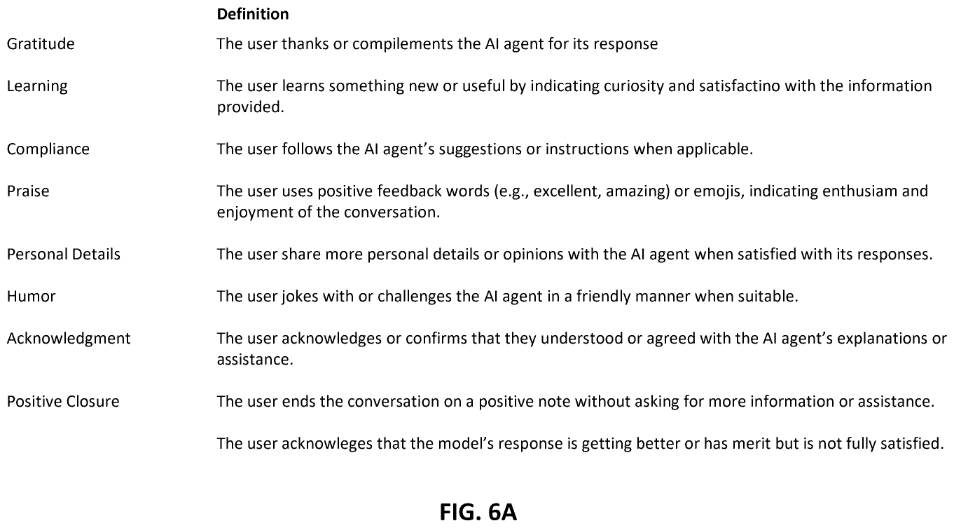

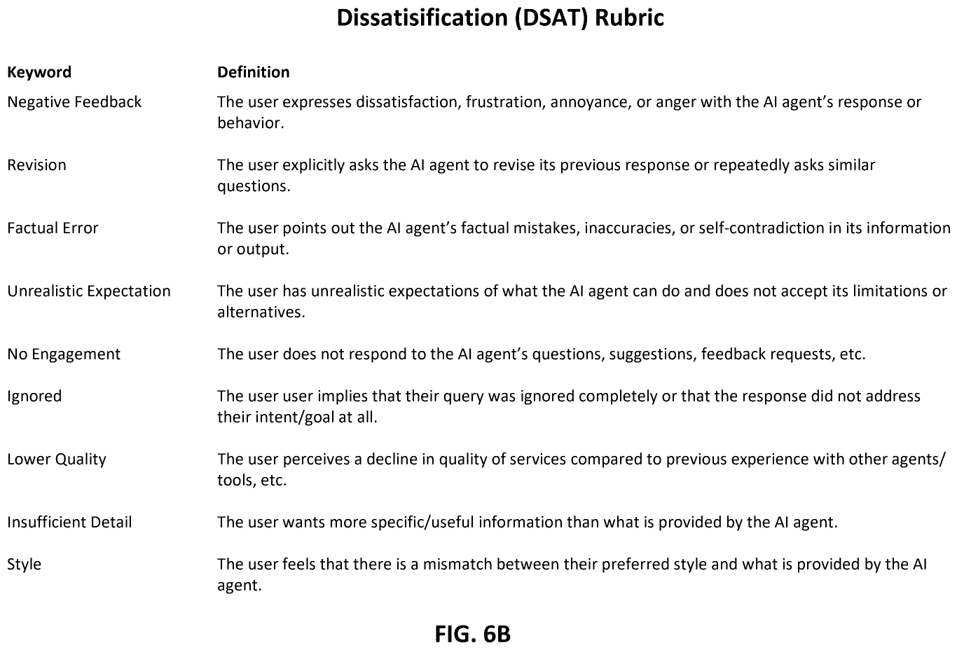

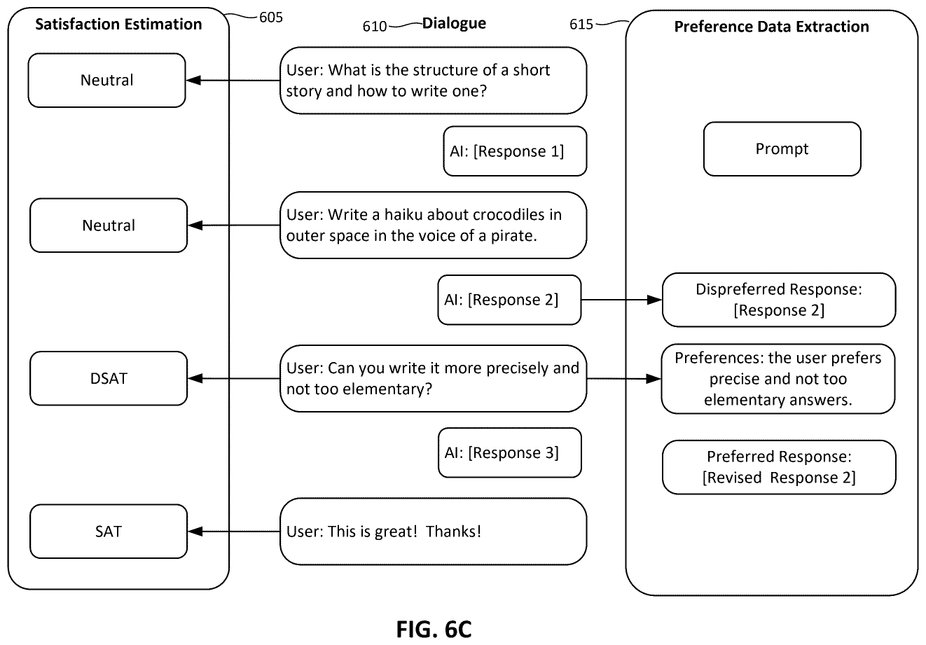

The feedback signal identification unit 202 estimates user satisfaction with a set of satisfaction rubrics and user dissatisfaction with a set of user dissatisfaction rubrics to generate the user preference dataset 160 that can be used to align the policy of the policy model 182 with these user preferences. Examples of the satisfaction rubrics are shown in FIG. 6A, and the examples of the dissatisfaction rubrics are shown in FIG. 6B.

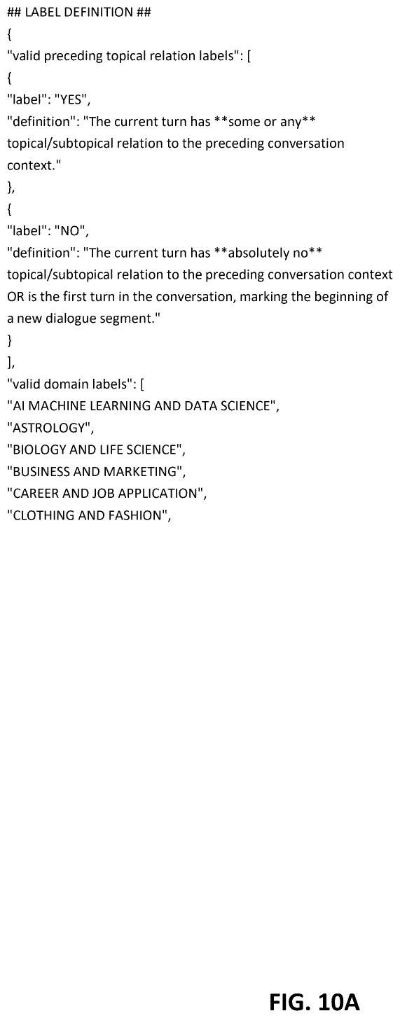

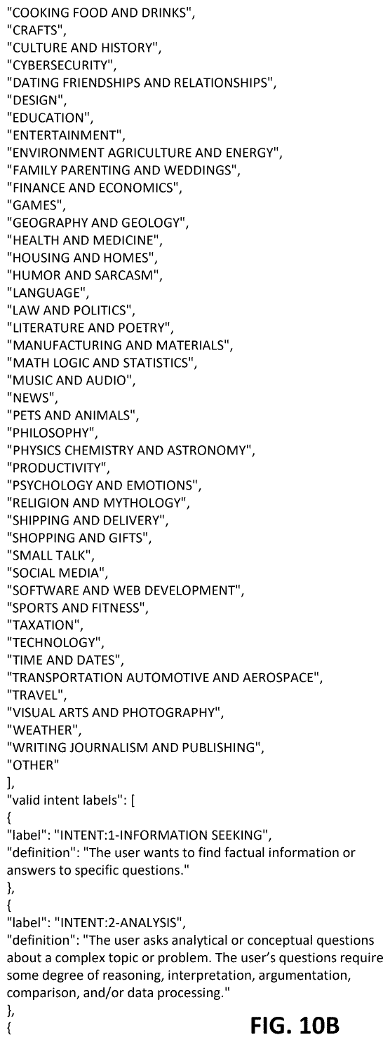

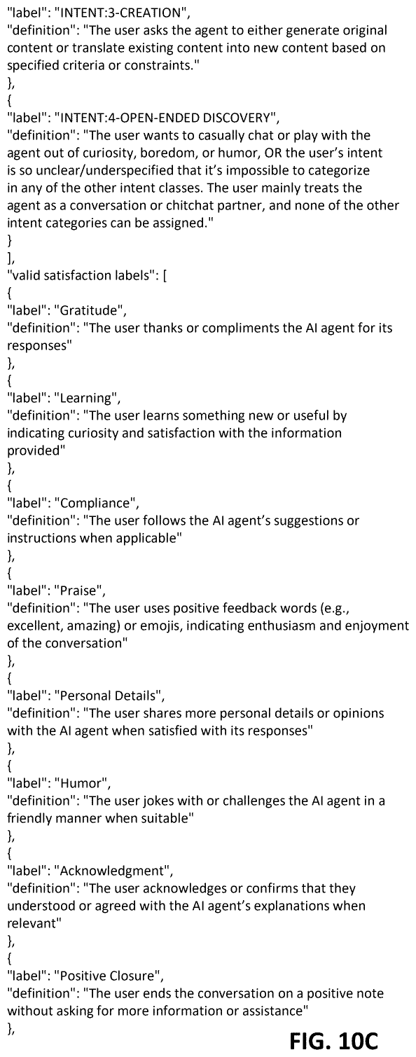

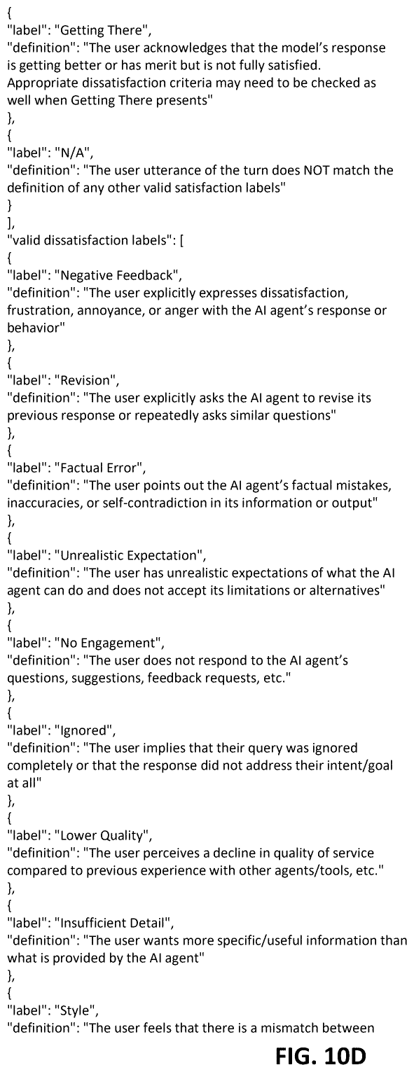

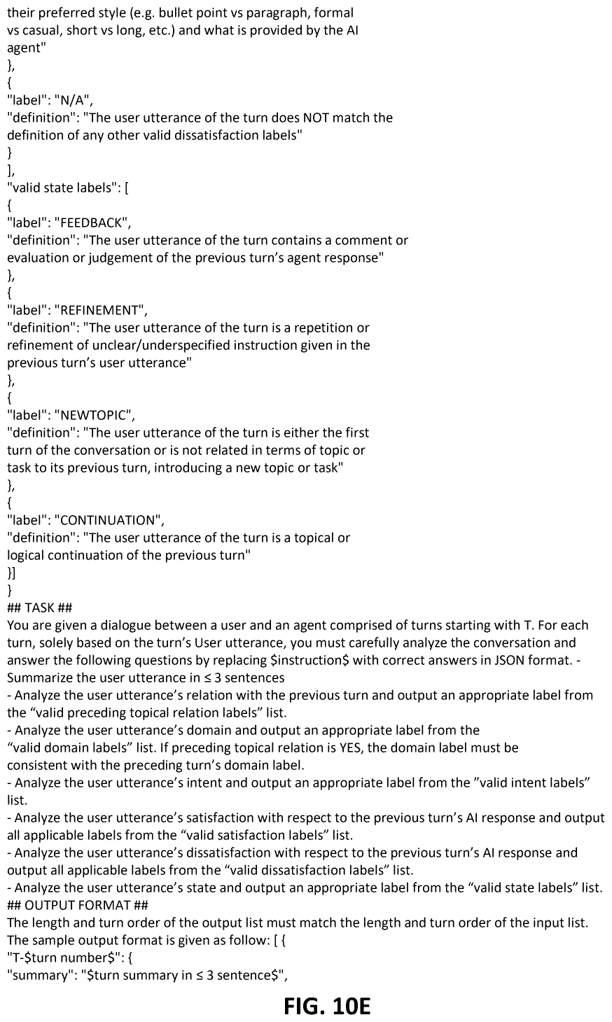

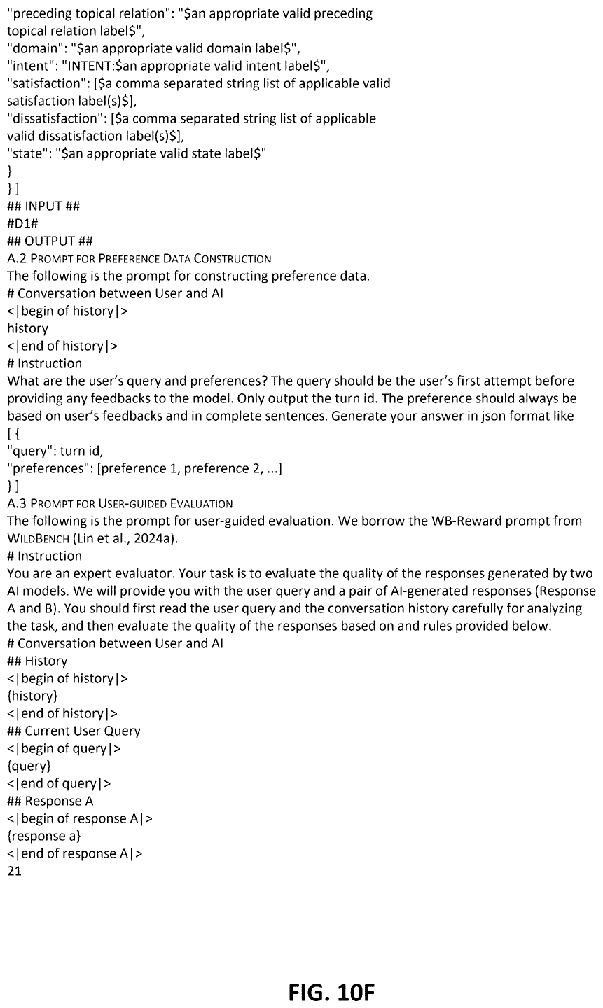

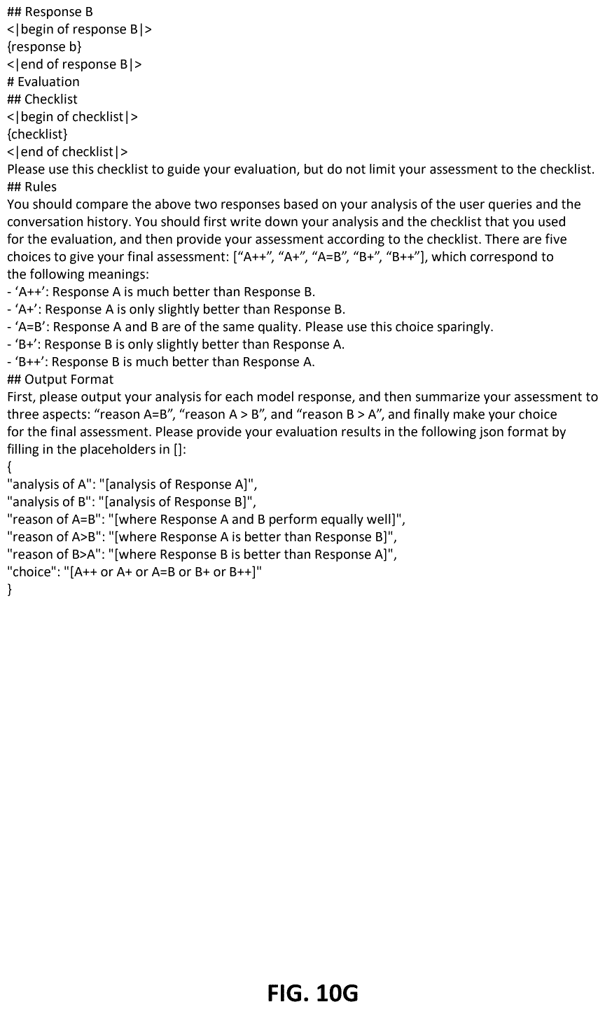

The feedback signal identification unit 202 constructs a prompt for the expert model 181 to cause the model to perform classification of user satisfaction at the utterance level based on the satisfaction and dissatisfaction rubrics. An example of one such prompt is included the prompt in FIGS. 10A-10G. Other implementations can utilize a different prompt. The prompt instructs the expert model 181 to analyze at least a portion of the in-situ user interactions with the LLM from the example user interaction dataset 170 according to these rubrics to generate feedback signal information for the user utterances in the multi-turn conversational session. FIG. 6C shows an example of such feedback signals having been applied to the user's utterances in an example conversational session. The satisfaction estimation column 605 includes the classifications applied to each of the user's utterances by the feedback signal identification unit 202 based on the satisfaction and dissatisfaction rubrics shown in FIGS. 6A and 6B. The dialogue between the user and the LLM (referenced as the “AI” in the dialog) is shown in the dialogue column 610. The dialogue includes the user utterances and the responses generated by the LLM. The preference data extraction column 615 will be discussed in detail with respect to the preference data construction unit 204.

The preference data construction unit 204 generates preference training data to be included in the user preference dataset 160. The preference training data includes samples that include: a prompt, one or more preferred response to the prompt, and one or more dispreferred response to the prompt. A dispreferred response is a response from the LLM for which the feedback signal identification unit 202 determined that the user reaction to the response was one of dissatisfaction based on the dissatisfaction rubrics. A preferred response is a response from the LLM for which the feedback signal identification unit 202 determined that the user reaction to the response was one of satisfaction based on the satisfaction rubrics.

For conversations containing SAT/DSAT signals, the preference data construction unit 204 extracts the conversation up to the LLM response that triggers the SAT/DSAT signals and use this as the prompt for the preference data. By systematically applying the SAT/DSAT rubrics to classify user feedback, the preference data construction unit 204 accurately determine which model responses led to user satisfaction or dissatisfaction. The preference data construction unit 204 constructs a prompt instructing the expert model 181 to summarize the user preferences based on the SAT/DSAT signals. For instance, the example shown in FIG. 6C, the preference data extraction column 615 shows the data obtained by the preference data construction unit 204 used to create a sample for the preference training data. In the example shown in FIG. 6C, the preference data construction unit 204 prompts the expert model 181 to cause the expert model 181 generate a summary of the user preferences, which is that “the user prefers precise and not too elementary answers” in this particular example.

The preference data construction unit 204 takes different approaches to the preferred and dispreferred responses depending upon whether response was generated by an expert model or a policy model. As previously indicated, the user interaction dataset 170 being analyzed by the user preference evaluation pipeline 130 may have been generated through user interactions with the policy model 182 or another LLM. The other LLM can be an expert model, such as the expert model 181, which can be implemented by GPT-4 or another such expert model. The user interaction dataset 170 may also have been captured from user interactions with another policy model. Examples of the policy models include but are not limited to Phi 3, Mistral, or LLAMA 3.

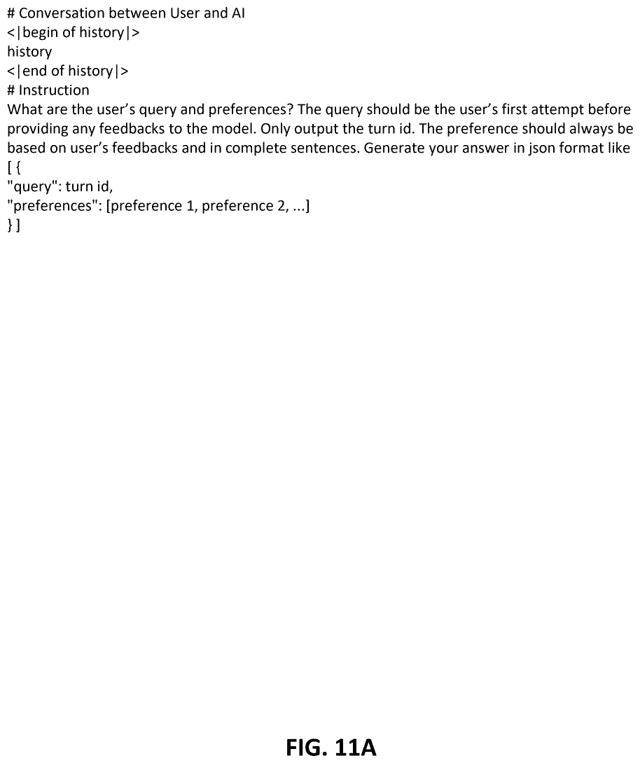

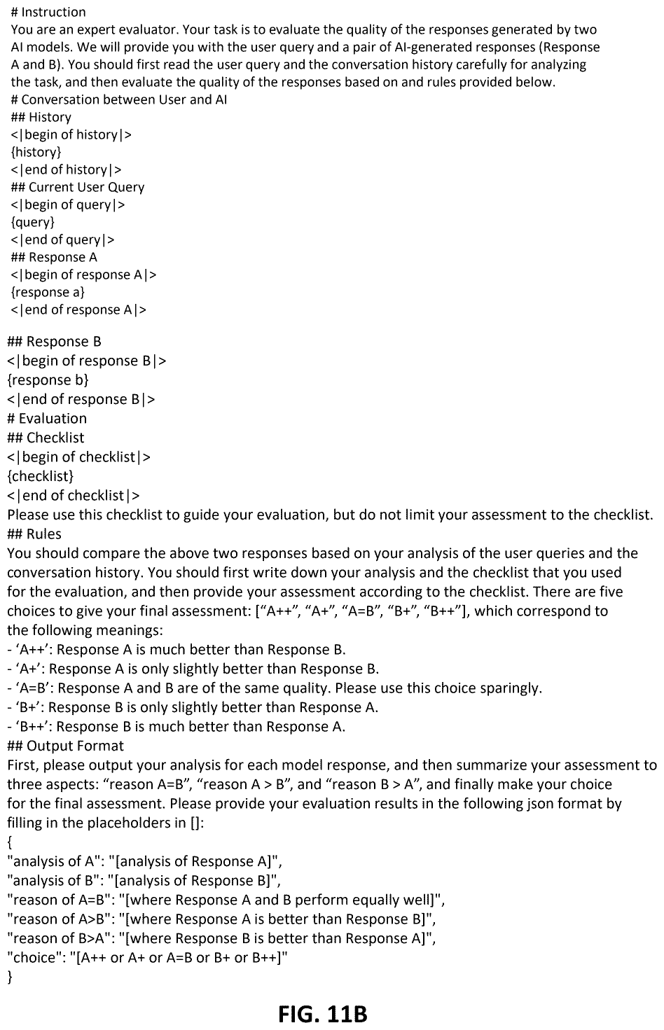

For responses generated by an expert model that trigger DSAT signals (indicating the user was dissatisfied with the response from the LLM), the responses that trigger the DSAT response are directly used by the preference data construction unit 204 as the dispreferred responses included in the user preference data. The preference data construction unit 204 then constructs a prompt to the expert model 181 to generate one or more synthetic preferred responses using the summarized user preferences. These synthetic preferred responses reflect the user preferences determined for the particular respective multi-turn conversational session. An example prompt is shown in FIG. 11. For responses generated by a policy model that trigger either DSAT, the responses that trigger the DSAT response are directly used by the preference data construction unit 204 as the dispreferred responses included in the user preference data. The preference data construction unit 204 then constructs a prompt to the policy model 182 to generate synthetic preferred responses using the summarized user preferences in a similar manner as is done for the expert model 181. The preference data construction unit 204 recognizes that some user preferences might be harmful in nature, and when prompting either the expert model 181 or the policy model 182 to generate the preferred responses, an extra layer of protection is added by explicitly including an instruction in the prompt that “the response should be safe” to avoid prompting the model to generate content based on harmful user preferences. The preference data construction unit 204 constructs a sample to include in the preference training data that includes the prompt, one or more preferred responses to the prompt, and one or more dispreferred responses to the prompt.

FIG. 3 is a diagram showing an example implementation of the model fine tuning pipeline 140 shown in FIG. 1. The model fine tuning pipeline 140 utilizes the user preference dataset 160 to fine-tune the training of the policy model 182 to better align the model with user preferences. As discussed above, the user preference data includes samples that include a prompt, one or more favored responses to the prompt, and one or more disfavored responses to the prompt.

The data access unit 302 accesses sample data from the user preference dataset 160 and provides the sample data as an input to the reward model training unit 304. The reward model training unit 304 trains a reward model on the user preference dataset 160. The reward model is an artificial intelligence model. The specific architecture of the reward model can vary from implementation to implementation. The reward model will be used to assess the output of the policy model 182 in response to sample data prompts and to adjust the policy of the model to be more likely to generate the favored responses from the user preference dataset 160 in response to a sample prompt and to be less likely to generate the disfavored responses.

The alignment unit 306 executes the reward model to evaluate the quality of the response from the policy model 182 in response to a sample prompt and assigns a score based on how well the response aligns with desired outcomes represented by the one or more favored responses. These scores are then used to fine-tune the policy model 182 to align the model with the values and expectations of the users. The alignment unit 306 adjusts the alignment of the policy model 182 by adjusting one or more parameters of the model to increase the probability of the policy model 182 generating response labeled as favorable and decreasing the probability of the policy model 182 generating response that are labeled as disfavored.

FIG. 4 is a diagram showing an example implementation of the model performance evaluation pipeline 190 shown in FIG. 1. The model performance evaluation pipeline 190 provides a user-guided evaluation framework that can be used to assess the alignment of LLMs with user preferences. The model performance evaluation pipeline 190 can be used to assess different versions of the same LLM, such as the policy model 182, where a first version of the model has not had been fine-tuned according to the techniques provided herein and a second version of the model has been fine-tuned according to the techniques herein to determine whether the fine-tuning has improved the alignment of the model. The model performance evaluation pipeline 190 can also be used to compare to two different fine-tune models having different model architectures to determine whether a particular model architecture has responded better to the alignment techniques provided herein. In an non-limiting example, the model performance evaluation pipeline 190 could be used to compare the performance of a fine-tuned Mistral model with the performance of a fine-tuned LLAMA 3 model to determine whether one of the fine-tuned models is better aligned with user preferences. A technical advantage of this approach is that the model performance evaluation pipeline 190 can be used to evaluate whether are particular model architecture is most appropriate for a particular application based on the alignment of that model with the user preferences of the users expected to utilize that model. The models being assessed by the model performance evaluation pipeline 190 can be implemented in a testing environment utilizing computing and memory resources of the application services platform 110 that have been allocated by the AI services 180.

The native application 114 and/or the web application 191 can provide a user interface that enables an authorized user to select the models to be tested, to initiate the testing by the model performance evaluation pipeline 190, and to present the results on a user interface of the native application 114 and/or the web application 191. The user interface can also include tools that enable the user to deploy the model that was more aligned with the user preferences to various production environments to enable the model to be utilized by users of the application services platform 110.

The data access unit 432 accesses samples for fine-tuning the alignment of the models from the user preference dataset 160. The data access unit provides these samples to the prompt construction unit 434. The prompt construction unit 434 constructs a first prompt for the first large language model 444 being assessed and a second prompt for the second large language model 446 being assessed. The first and second prompts may be identical in some implementations. However, the specific format of the prompts may be based at least in part on the architecture of the first large language model 444 and the second large language model 446. The prompt construction unit 434 can utilize prompt templates for constructing the prompts. The prompt templates can include language that has been specifically engineered to optimize the output of the specific models being assessed. The prompt construction unit 434 can also provide the sample used to construct the prompt to the response evaluation unit 438 so that the response evaluation unit 438 has the favored and disfavored responses for the prompt being assessed.

The prompt construction unit 434 provides the prompts to the prompt submission unit 436. The prompt submission unit 436 provides the prompts and an input to the first large language model 444 and the second large language model 446 and obtains a first response to the first large language model 444 and a second response from the second large language model 446. The prompt submission unit 436 provides the first and second responses to the response evaluation unit 438 to evaluate whether the response from the first large language model 444 or the second large language model 446 was better aligned with the user preferences. In some implementations, the response evaluation unit 438 utilizes the expert model 181 to evaluate the responses from the first large language model 444 and the second large language model 446. An example prompt for implementing this comparison is shown in FIG. 12. In other implementations, the response evaluation unit 438 utilizes a rewards model similar to that utilized by the model fine tuning pipeline 140 to determine an alignment score for each of the models for the prompt. The response evaluation unit 438 can also utilize other techniques for assessing the alignment of the outputs from the first large language model 444 or the second large language model 446 in other implementations. The response evaluation unit 438 outputs information to the model performance dataset 192 that indicates how the first large language model 444 or the second large language model 446 performed individually on the prompts included in the user preference dataset 160 and collectively which model was most aligned with user preferences. A technical benefit of this approach is that the performance of fine-tuned models can automatically be compared with versions of the model that have not been fine tuned and/or with other model architectures that have also been fine tuned to ensure that the model that is best aligned with user preferences can be deployed.

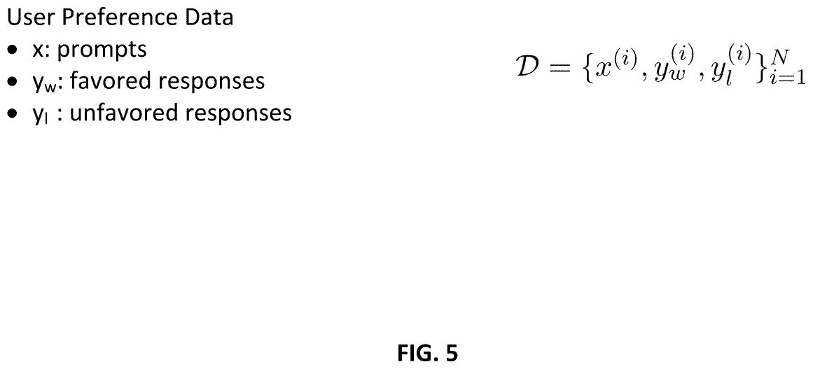

FIG. 5 is a diagram showing an example of the format of the preference data used in preference training included in the user preference dataset 160. The user preference dataset 160 is represented by D, the dataset includes N samples where N is an integer value. Each prompt x, is associated with one or more favored responses y_{w}, and one or more disfavored responses yₗ. The user preference dataset 160 can be generated by the user preference evaluation pipeline 130.

FIG. 6A is an example of satisfaction rubrics that are used to determine user preferences according to the techniques disclosed herein, and FIG. 6B is an example of dissatisfaction rubrics that are used to determine user preferences according to the techniques disclosed herein. These rubrics are based at least in part on the Supervised Prompting for User Satisfaction Rubrics (SPUR) introduced in by Lin et al. in their paper entitled “Interpretable User Satisfaction Estimated for Conversational Systems with Large Language Models.” A technical advantage of this approach is that these rubrics provide a novel framework for estimating user satisfaction in conversational systems and provide clear and interpretable rubrics that enable an LLM, such as the expert model 181, to classify user satisfaction. As result, the framework provided herein is able to automatically, efficiently, and accurately estimate user satisfaction to enable the framework to develop user preference datasets that can be used to align LLMs with user preferences.

FIG. 6C is an example of the satisfaction and dissatisfaction rubrics shown in FIGS. 6A and 6B being applied to an example user interaction with a language model according to the techniques disclosed herein. FIG. 6C shows an example of these rubrics having been used to classify the user satisfaction or dissatisfaction with the responses provided by the policy model 182. The satisfaction estimation column 605 includes the classifications applied to each of the user's utterances by the feedback signal identification unit 202 based on the satisfaction and dissatisfaction rubrics. The dialogue between the user and the LLM (referenced as the “AI” in the dialog) is shown in the dialogue column 610. The dialogue includes the user utterances and the responses generated by the LLM. The preference data construction unit 204 uses this information to construct the sample data to be included in the user preference dataset 160 which can then be used to fine-tune the policy model 182 to be more aligned with user preferences.

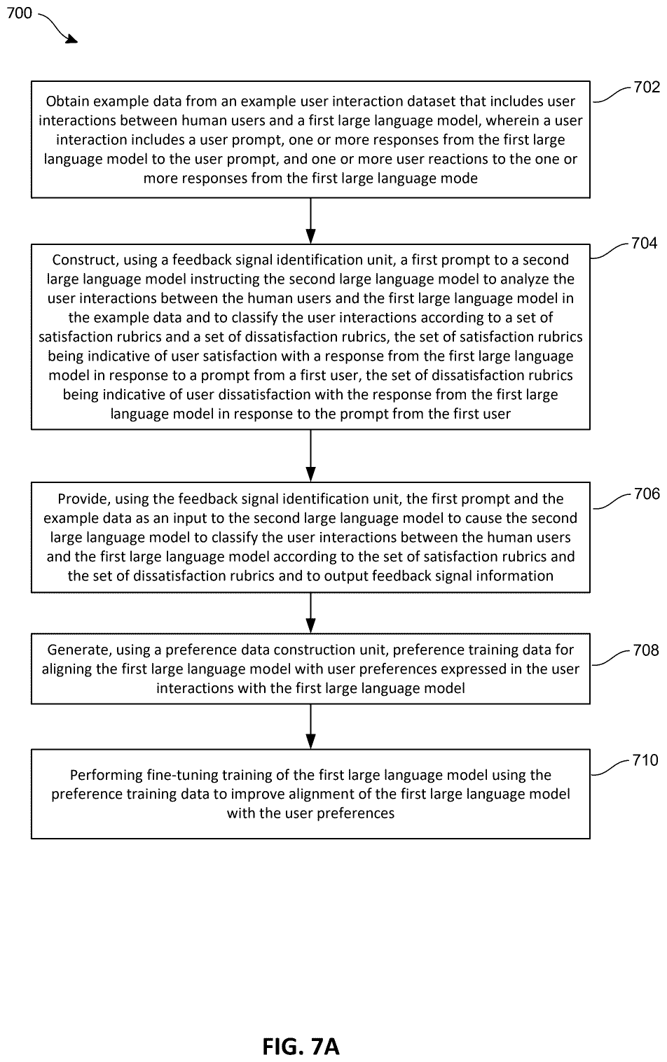

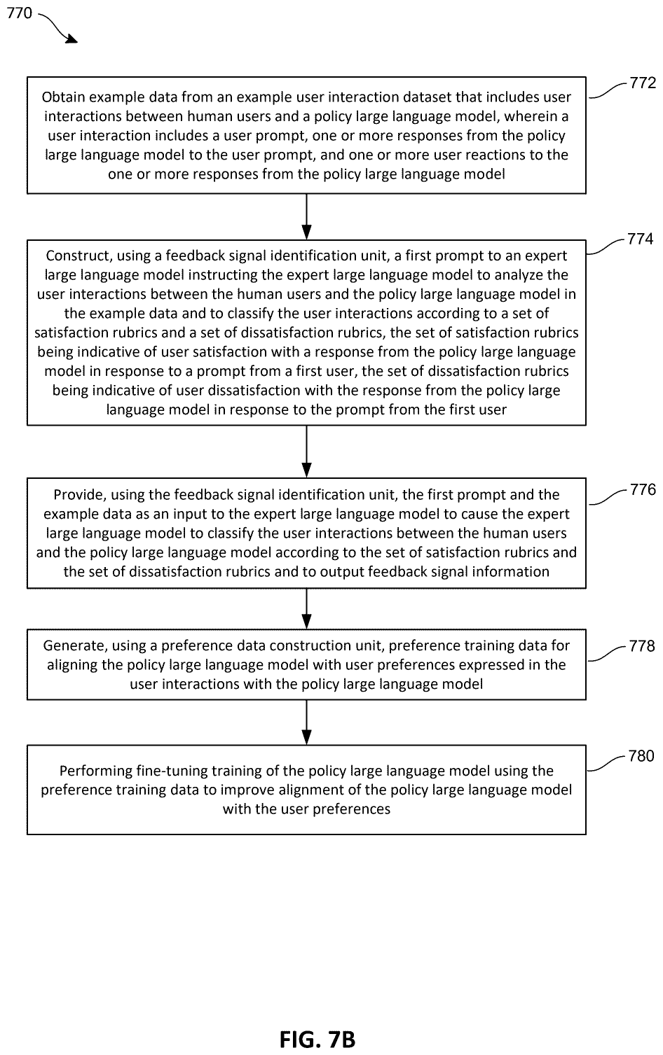

FIG. 7A is a flow chart of an example process 700 for aligning a large language model with user preferences according to the techniques disclosed herein. The process 770 can be implemented by the user preference evaluation pipeline 130 and/or other components of the application services platform 110 shown in FIGS. 1 and 2.

The process 700 includes an operation 702 of obtaining example data from an example user interaction dataset 170 that includes user interactions between human users and a first large language model. A user interaction includes a user prompt, one or more responses from the first large language model to the user prompt, and one or more user reactions to the one or more responses from the first large language model as discussed in the preceding examples.

The process 700 includes an operation 704 of constructing, using a feedback signal identification unit 202, a first prompt to a second large language model instructing the second large language model to analyze the user interactions between the human users and the first large language model in the example data and to classify the user interactions according to a set of satisfaction rubrics and a set of dissatisfaction rubrics. The set of satisfaction rubrics are indicative of user satisfaction with a response from the first large language model in response to a prompt from a first user, and the set of dissatisfaction rubrics are indicative of user dissatisfaction with the response from the first large language model in response to the prompt from the first user. Examples of such rubrics are provided in FIGS. 6A and 6B.

The process 700 includes an operation 706 of providing, using the feedback signal identification unit 202, the first prompt and the example data as an input to the second large language model to cause the second large language model to classify the user interactions between the human users and the first large language model according to the set of satisfaction rubrics and the set of dissatisfaction rubrics and to output feedback signal information.

The process 700 includes an operation 708 of generating, using a preference data construction unit 204, preference training data for aligning the first large language model with user preferences expressed in the user interactions with the first large language model. The preference data construction unit 204 generates the preference training data based on the feedback signal information output by the feedback signal identification unit 202.

The process 700 includes an operation 710 of fine-tuning training of the first large language model using the preference training data to improve alignment of the first large language model with the user preferences. The model fine tuning pipeline 140 can utilize the user preference dataset 160 to fine tune the policy model 182 to more closely align with the user preferences.

FIG. 7B is a flow chart of another example process 770 for aligning a large language model with user preferences according to the techniques disclosed herein. The process 770 can be implemented by the user preference evaluation pipeline 130 and/or other components of the application services platform 110 shown in FIGS. 1 and 2.

The process 770 includes an operation 772 of obtaining example data from an example user interaction dataset that includes user interactions between human users and a policy large language model. A user interaction includes a user prompt, one or more responses from the first large language model to the user prompt, and one or more user reactions to the one or more responses from the first large language model as discussed in the preceding examples.

The process 770 includes an operation 774 of constructing, using a feedback signal identification unit, a first prompt to an expert large language model instructing the expert large language model to analyze the user interactions between the human users and the policy large language model in the example data and to classify the user interactions according to a set of satisfaction rubrics and a set of dissatisfaction rubrics, The set of satisfaction rubrics are indicative of user satisfaction with a response from the first large language model in response to a prompt from a first user, and the set of dissatisfaction rubrics are indicative of user dissatisfaction with the response from the first large language model in response to the prompt from the first user. Examples of such rubrics are provided in FIGS. 6A and 6B.

The process 770 includes an operation 776 of providing, using the feedback signal identification unit 202, the first prompt and the example data as an input to the expert large language model to cause the expert large language model to classify the user interactions between the human users and the policy large language model according to the set of satisfaction rubrics and the set of dissatisfaction rubrics and to output feedback signal information.

The process 770 includes an operation 778 of generating, using a preference data construction unit 204, preference training data for aligning the policy large language model with user preferences expressed in the user interactions with the policy large language model.

The process 770 includes an operation 780 of performing fine-tuning training of the policy large language model using the preference training data to improve alignment of the policy large language model with the user preferences. The model fine tuning pipeline 140 can utilize the user preference dataset 160 to fine tune the policy model 182 to more closely align with the user preferences.

The detailed examples of systems, devices, and techniques described in connection with FIGS. 1-7B are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-7B are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

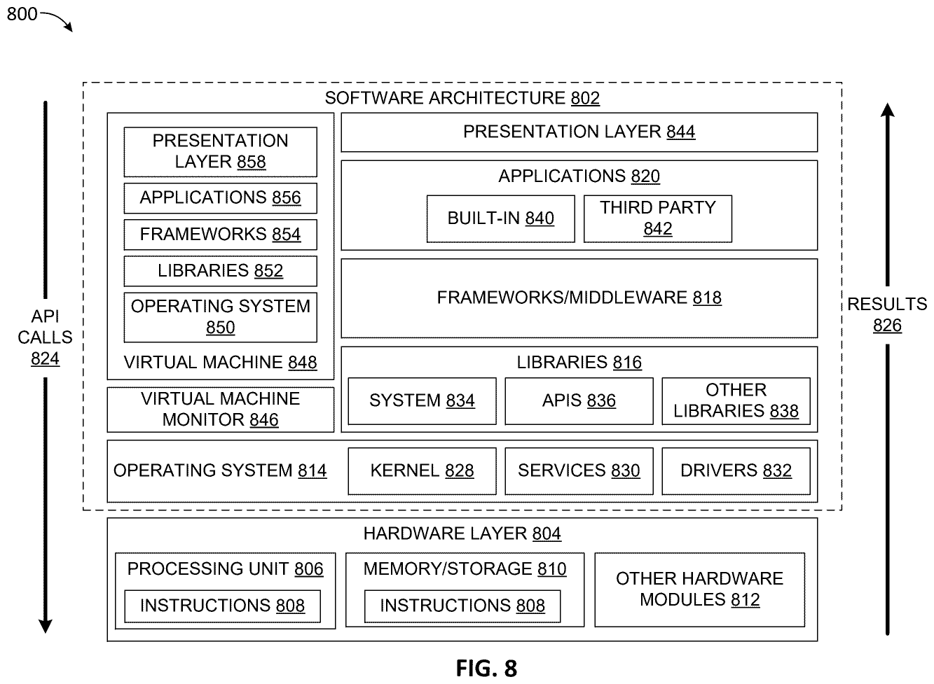

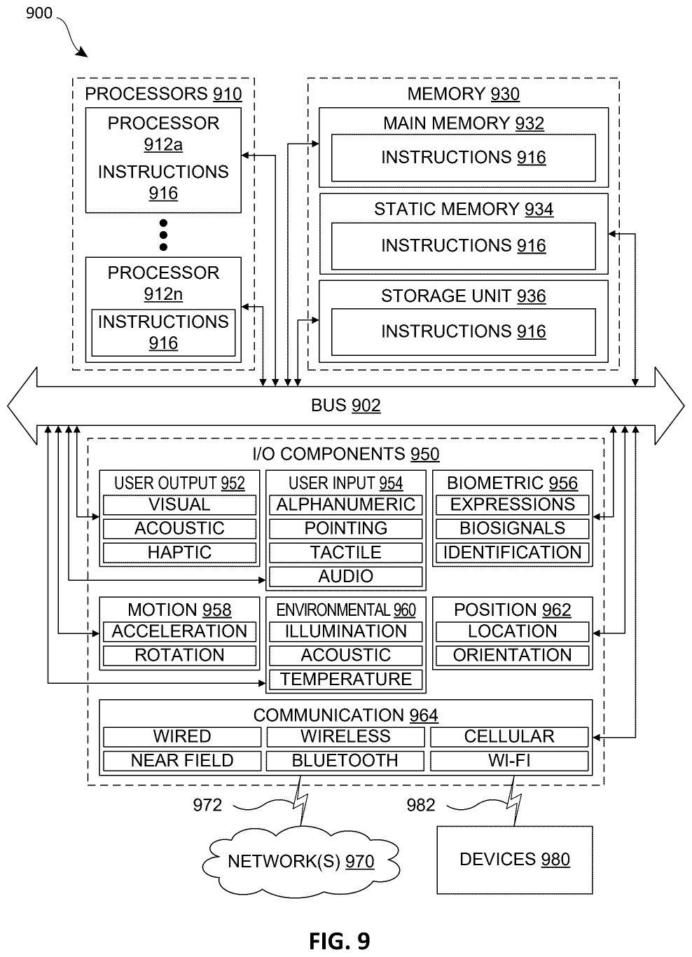

FIG. 8 is a block diagram 800 illustrating an example software architecture 802, various portions of which may be used in conjunction with various hardware architectures herein described, which may implement any of the above-described features. FIG. 8 is a non-limiting example of a software architecture, and it will be appreciated that many other architectures may be implemented to facilitate the functionality described herein. The software architecture 802 may execute on hardware such as a machine 900 of FIG. 9 that includes, among other things, processors 910, memory/storage, and input/output (I/O) components 950. A representative hardware layer 804 is illustrated and can represent, for example, the machine 900 of FIG. 9. The representative hardware layer 804 includes a processing unit 806 and associated executable instructions 808. The executable instructions 808 represent executable instructions of the software architecture 802, including implementation of the methods, modules and so forth described herein. The hardware layer 804 also includes a memory/storage 810, which also includes the executable instructions 808 and accompanying data. The hardware layer 804 may also include other hardware modules 812. Instructions 808 held by processing unit 806 may be portions of instructions 808 held by the memory/storage 810.

The example software architecture 802 may be conceptualized as layers, each providing various functionality. For example, the software architecture 802 may include layers and components such as an operating system (OS) 814, libraries 816, frameworks/middleware 818, applications 820, and a presentation layer 844. Operationally, the applications 820 and/or other components within the layers may invoke API calls 824 to other layers and receive corresponding results 826. The layers illustrated are representative in nature and other software architectures may include additional or different layers. For example, some mobile or special purpose operating systems may not provide the frameworks/middleware 818.

The OS 814 may manage hardware resources and provide common services. The OS 814 may include, for example, a kernel 828, services 830, and drivers 832. The kernel 828 may act as an abstraction layer between the hardware layer 804 and other software layers. For example, the kernel 828 may be responsible for memory management, processor management (for example, scheduling), component management, networking, security settings, and so on. The services 830 may provide other common services for the other software layers. The drivers 832 may be responsible for controlling or interfacing with the underlying hardware layer 804. For instance, the drivers 832 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 816 may provide a common infrastructure that may be used by the applications 820 and/or other components and/or layers. The libraries 816 typically provide functionality for use by other software modules to perform tasks, rather than interacting directly with the OS 814. The libraries 816 may include system libraries 834 (for example, C standard library) that may provide functions such as memory allocation, string manipulation, file operations. In addition, the libraries 816 may include API libraries 836 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 816 may also include a wide variety of other libraries 838 to provide many functions for applications 820 and other software modules.

The frameworks/middleware 818 provide a higher-level common infrastructure that may be used by the applications 820 and/or other software modules. For example, the frameworks/middleware 818 may provide various graphic user interface (GUI) functions, high-level resource management, or high-level location services. The frameworks/middleware 818 may provide a broad spectrum of other APIs for applications 820 and/or other software modules.

The applications 820 include built-in applications 840 and/or third-party applications 842. Examples of built-in applications 840 may include, but are not limited to, a contacts application, a browser application, a location application, a media application, a messaging application, and/or a game application. Third-party applications 842 may include any applications developed by an entity other than the vendor of the particular platform. The applications 820 may use functions available via OS 814, libraries 816, frameworks/middleware 818, and presentation layer 844 to create user interfaces to interact with users.

Some software architectures use virtual machines, as illustrated by a virtual machine 848. The virtual machine 848 provides an execution environment where applications/modules can execute as if they were executing on a hardware machine (such as the machine 900 of FIG. 9, for example). The virtual machine 848 may be hosted by a host OS (for example, OS 814) or hypervisor, and may have a virtual machine monitor 846 which manages operation of the virtual machine 848 and interoperation with the host operating system. A software architecture, which may be different from software architecture 802 outside of the virtual machine, executes within the virtual machine 848 such as an OS 850, libraries 852, frameworks 854, applications 856, and/or a presentation layer 858.

FIG. 9 is a block diagram illustrating components of an example machine 900 configured to read instructions from a machine-readable medium (for example, a machine-readable storage medium) and perform any of the features described herein. The example machine 900 is in a form of a computer system, within which instructions 916 (for example, in the form of software components) for causing the machine 900 to perform any of the features described herein may be executed. As such, the instructions 916 may be used to implement modules or components described herein. The instructions 916 cause unprogrammed and/or unconfigured machine 900 to operate as a particular machine configured to carry out the described features. The machine 900 may be configured to operate as a standalone device or may be coupled (for example, networked) to other machines. In a networked deployment, the machine 900 may operate in the capacity of a server machine or a client machine in a server-client network environment, or as a node in a peer-to-peer or distributed network environment. Machine 900 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 900 is illustrated, the term “machine” includes a collection of machines that individually or jointly execute the instructions 916.

The machine 900 may include processors 910, memory/storage 930, and I/O components 950, which may be communicatively coupled via, for example, a bus 902. The bus 902 may include multiple buses coupling various elements of machine 900 via various bus technologies and protocols. In an example, the processors 910 (including, for example, a central processing unit (CPU), a graphics processing unit (GPU), a digital signal processor (DSP), an ASIC, or a suitable combination thereof) may include one or more processors 912a to 912n that may execute the instructions 916 and process data. In some examples, one or more processors 910 may execute instructions provided or identified by one or more other processors 910. The term “processor” includes a multicore processor including cores that may execute instructions contemporaneously. Although FIG. 9 shows multiple processors, the machine 900 may include a single processor with a single core, a single processor with multiple cores (for example, a multicore processor), multiple processors each with a single core, multiple processors each with multiple cores, or any combination thereof. In some examples, the machine 900 may include multiple processors distributed among multiple machines.

The memory/storage 930 may include a main memory 932, a static memory 934, or other memory, and a storage unit 936, both accessible to the processors 910 such as via the bus 902. The storage unit 936 and memory 932, 934 store instructions 916 embodying any one or more of the functions described herein. The memory/storage 930 may also store temporary, intermediate, and/or long-term data for processors 910. The instructions 916 may also reside, completely or partially, within the memory 932, 934, within the storage unit 936, within at least one of the processors 910 (for example, within a command buffer or cache memory), within memory at least one of I/O components 950, or any suitable combination thereof, during execution thereof. Accordingly, the memory 932, 934, the storage unit 936, memory in processors 910, and memory in I/O components 950 are examples of machine-readable media.

As used herein, “machine-readable medium” refers to a device able to temporarily or permanently store instructions and data that cause machine 900 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 916) for execution by a machine 900 such that the instructions, when executed by one or more processors 910 of the machine 900, cause the machine 900 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 950 may include a wide variety of hardware components adapted to receive input, provide output, produce output, transmit information, exchange information, capture measurements, and so on. The specific I/O components 950 included in a particular machine will depend on the type and/or function of the machine. For example, mobile devices such as mobile phones may include a touch input device, whereas a headless server or IoT device may not include such a touch input device. The particular examples of I/O components illustrated in FIG. 9 are in no way limiting, and other types of components may be included in machine 900. The grouping of I/O components 950 are merely for simplifying this discussion, and the grouping is in no way limiting. In various examples, the I/O components 950 may include user output components 952 and user input components 954. User output components 952 may include, for example, display components for displaying information (for example, a liquid crystal display (LCD) or a projector), acoustic components (for example, speakers), haptic components (for example, a vibratory motor or force-feedback device), and/or other signal generators. User input components 954 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 950 may include biometric components 956, motion components 958, environmental components 960, and/or position components 962, among a wide array of other physical sensor components. The biometric components 956 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 958 may include, for example, acceleration sensors (for example, an accelerometer) and rotation sensors (for example, a gyroscope). The environmental components 960 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 962 may include, for example, location sensors (for example, a Global Position System (GPS) receiver), altitude sensors (for example, an air pressure sensor from which altitude may be derived), and/or orientation sensors (for example, magnetometers).

The I/O components 950 may include communication components 964, implementing a wide variety of technologies operable to couple the machine 900 to network(s) 970 and/or device(s) 980 via respective communicative couplings 972 and 982. The communication components 964 may include one or more network interface components or other suitable devices to interface with the network(s) 970. The communication components 964 may include, for example, components adapted to provide wired communication, wireless communication, cellular communication, Near Field Communication (NFC), Bluetooth communication, Wi-Fi, and/or communication via other modalities. The device(s) 980 may include other machines or various peripheral devices (for example, coupled via USB).

In some examples, the communication components 964 may detect identifiers or include components adapted to detect identifiers. For example, the communication components 964 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 964, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory storing executable instructions that, when executed, cause the processor alone or in combination with other processors to perform operations of:
obtaining example data from an example user interaction dataset that includes user interactions between human users and a first large language model, wherein a user interaction includes a user prompt, one or more responses from the first large language model to the user prompt, and one or more user reactions to the one or more responses from the first large language model;
constructing, using a feedback signal identification unit, a first prompt to a second large language model instructing the second large language model to analyze the user interactions between the human users and the first large language model in the example data and to classify the user interactions according to a set of satisfaction rubrics and a set of dissatisfaction rubrics, the set of satisfaction rubrics being indicative of user satisfaction with a response from the first large language model in response to a prompt from a first user, the set of dissatisfaction rubrics being indicative of user dissatisfaction with the response from the first large language model in response to the prompt from the first user;
providing, using the feedback signal identification unit, the first prompt and the example data as an input to the second large language model to cause the second large language model to classify the user interactions between the human users and the first large language model according to the set of satisfaction rubrics and the set of dissatisfaction rubrics and to output feedback signal information;
generating, using a preference data construction unit, preference training data for aligning the first large language model with user preferences expressed in the user interactions with the first large language model; and
performing fine-tuning training of the first large language model using the preference training data to improve alignment of the first large language model with the user preferences.

2. The data processing system of claim 1, wherein the first large language model is a policy language model for which a policy of the first large language model is to be aligned with the user preferences.

3. The data processing system of claim 1, wherein the second large language model is a Generative Pre-Trained Transformer (GPT) language model.

4. The data processing system of claim 1, wherein the example data includes user interactions associated with one or more multi-turn conversational sessions, and wherein to generate the preference training data, the memory further stores executable instructions that, when executed, cause the processor alone or in combination with other processors to perform operations of:
constructing, for each multi-turn conversational sessions, a prompt to the second large language model to cause the second large language model to summarize one or more user reactions to responses generated by the first large language model to generate a summary of the user preferences.

5. The data processing system of claim 4, wherein the memory further stores executable instructions that, when executed, cause the processor alone or in combination with other processors to perform operations of:
determining that a respective multi-turn conversational session of the one or more multi-turn conversational sessions was conducted with an expert language model;
constructing, for the respective multi-turn conversational session, a second prompt to the second large language model to cause the second large language model to generate one or more synthetic favored responses based on the summary of the user preferences associated with the respective multi-turn conversational session;
providing the second prompt as an input to the second large language model to obtain the summary of the user preferences; and
constructing, for the respective multi-turn conversational session, a sample to include in the preference training data comprising the user prompt, the one or more synthetic favored responses, and one or more disfavored responses generated by the first large language model.

6. The data processing system of claim 4, wherein the memory further stores executable instructions that, when executed, cause the processor alone or in combination with other processors to perform operations of:
determining that a respective multi-turn conversational session of the one or more multi-turn conversational sessions was conducted with a policy language model;
constructing, for the respective multi-turn conversational session, a second prompt to the first large language model to cause the first large language model to generate one or more synthetic favored responses based on the summary of the user preferences associated with the respective multi-turn conversational session;
providing the second prompt as an input to the first large language model to obtain the summary of the user preferences; and
constructing, for the respective multi-turn conversational session, a sample to include in the preference training data comprising the user prompt, the one or more synthetic favored responses, and one or more disfavored responses generated by the first large language model.

7. The data processing system of claim 6, wherein the memory further stores executable instructions that, when executed, cause the processor alone or in combination with other processors to perform operations of:
constructing the second prompt to include a safety check to prevent the first large language model from generating the summary of the user preferences responsive to the user preferences including one or more unsafe preferences that could cause the first large language model to generate unsafe or offensive content.

8. The data processing system of claim 1, wherein the memory further stores executable instructions that, when executed, cause the processor alone or in combination with other processors to perform operations of:
constructing a series of third prompts for a third language model based on the preference training data;
providing the series of third prompts as an input to the third language model to obtain a series of first responses from the third language model;
constructing a fourth prompt for a fourth language model based on the preference training data;
providing the series of fourth prompts as an input to the fourth language model to obtain a series of second responses from the fourth language model; and
analyzing the series of first response and the series of second responses to determine whether the third language model or the fourth language model is more closely aligned with the user preferences.

9. A method implemented in a data processing system for aligning a large language model with user preferences, the method comprising:
obtaining example data from an example user interaction dataset that includes user interactions between human users and a first large language model, wherein a user interaction includes a user prompt, one or more responses from the first large language model to the user prompt, and one or more user reactions to the one or more responses from the first large language model;
constructing, using a feedback signal identification unit, a first prompt to a second large language model instructing the second large language model to analyze the user interactions between the human users and the first large language model in the example data and to classify the user interactions according to a set of satisfaction rubrics and a set of dissatisfaction rubrics, the set of satisfaction rubrics being indicative of user satisfaction with a response from the first large language model in response to a prompt from a first user, the set of dissatisfaction rubrics being indicative of user dissatisfaction with the response from the first large language model in response to the prompt from the first user;
providing, using the feedback signal identification unit, the first prompt and the example data as an input to the second large language model to cause the second large language model to classify the user interactions between the human users and the first large language model according to the set of satisfaction rubrics and the set of dissatisfaction rubrics and to output feedback signal information;
generating, using a preference data construction unit, preference training data for aligning the first large language model with user preferences expressed in the user interactions with the first large language model; and
performing fine-tuning training of the first large language model using the preference training data to improve alignment of the first large language model with the user preferences.

10. The method of claim 9, wherein the first large language model is a policy language model for which a policy of the first large language model is to be aligned with the user preferences.

11. The method of claim 9, wherein the second large language model is a Generative Pre-Trained Transformer (GPT) language model.

12. The method of claim 9, wherein the example data includes user interactions associated with one or more multi-turn conversational sessions, and generating the preference training data further comprises:
constructing, for each multi-turn conversational sessions, a prompt to the second large language model to cause the second large language model to summarize one or more user reactions to responses generated by the first large language model to generate a summary of the user preferences.

13. The method of claim 12, further comprising:
determining that a respective multi-turn conversational session of the one or more multi-turn conversational sessions was conducted with an expert language model;
constructing, for the respective multi-turn conversational session, a second prompt to the second large language model to cause the second large language model to generate one or more synthetic favored responses based on the summary of the user preferences associated with the respective multi-turn conversational session;
providing the second prompt as an input to the second large language model to obtain the summary of the user preferences; and
constructing, for the respective multi-turn conversational session, a sample to include in the preference training data comprising the user prompt, the one or more synthetic favored responses, and one or more disfavored responses generated by the first large language model.

14. The method of claim 12, further comprising:
determining that a respective multi-turn conversational session of the one or more multi-turn conversational sessions was conducted with a policy language model;
constructing, for the respective multi-turn conversational session, a second prompt to the first large language model to cause the first large language model to generate one or more synthetic favored responses based on the summary of the user preferences associated with the respective multi-turn conversational session;
providing the second prompt as an input to the first large language model to obtain the summary of the user preferences; and
constructing, for the respective multi-turn conversational session, a sample to include in the preference training data comprising the user prompt, the one or more synthetic favored responses, and one or more disfavored responses generated by the first large language model.

15. The method of claim 14, further comprising:
constructing the second prompt to include a safety check to prevent the first large language model from generating the summary of the user preferences responsive to the user preferences including one or more unsafe preferences that could cause the first large language model to generate unsafe or offensive content.

16. A data processing system comprising:
a processor; and
a memory storing executable instructions that, when executed, cause the processor alone or in combination with other processors to perform operations of:
obtaining example data from an example user interaction dataset that includes user interactions between human users and a policy large language model, wherein a user interaction includes a user prompt, one or more responses from the policy large language model to the user prompt, and one or more user reactions to the one or more responses from the policy large language model;
constructing, using a feedback signal identification unit, a first prompt to an expert large language model instructing the expert large language model to analyze the user interactions between the human users and the policy large language model in the example data and to classify the user interactions according to a set of satisfaction rubrics and a set of dissatisfaction rubrics, the set of satisfaction rubrics being indicative of user satisfaction with a response from the policy large language model in response to a prompt from a first user, the set of dissatisfaction rubrics being indicative of user dissatisfaction with the response from the policy large language model in response to the prompt from the first user;
providing, using the feedback signal identification unit, the first prompt and the example data as an input to the expert large language model to cause the expert large language model to classify the user interactions between the human users and the policy large language model according to the set of satisfaction rubrics and the set of dissatisfaction rubrics and to output feedback signal information;
generating, using a preference data construction unit, preference training data for aligning the policy large language model with user preferences expressed in the user interactions with the policy large language model; and
performing fine-tuning training of the policy large language model using the preference training data to improve alignment of the policy large language model with the user preferences.

17. The data processing system of claim 16, wherein the policy large language model is a policy language model for which a policy of the policy large language model is to be aligned with the user preferences.

18. The data processing system of claim 16, wherein the expert large language model is a Generative Pre-Trained Transformer (GPT) language model.

19. The data processing system of claim 16, wherein the example data includes user interactions associated with one or more multi-turn conversational sessions, and wherein to generate the preference training data, the memory further stores executable instructions that, when executed, cause the processor alone or in combination with other processors to perform operations of:
constructing, for each multi-turn conversational sessions, a prompt to the expert large language model to cause the expert large language model to summarize one or more user reactions to responses generated by the policy large language model to generate a summary of the user preferences.

20. The data processing system of claim 19, wherein the memory further stores executable instructions that, when executed, cause the processor alone or in combination with other processors to perform operations of:
determining that a respective multi-turn conversational session of the one or more multi-turn conversational sessions was conducted with an expert language model;
constructing, for the respective multi-turn conversational session, a second prompt to the expert large language model to cause the expert large language model to generate one or more synthetic favored responses based on the summary of the user preferences associated with the respective multi-turn conversational session;
providing the second prompt as an input to the expert large language model to obtain the summary of the user preferences; and
constructing, for the respective multi-turn conversational session, a sample to include in the preference training data comprising the user prompt, the one or more synthetic favored responses, and one or more disfavored responses generated by the policy large language model.
